(19) United States
(12) Patent Application Publication
(10) Pub. No.: US 2012/0261437 A1
(43) Pub. Date: Oct. 18, 2012

(54) METHOD AND APPARATUS FOR PREVENTION AND DETECTION OF PHASE SEPARATION IN STORAGE TANKS

(75) Inventors: Lorraine Vander Wielen Sabo, Sun Prairie, WI (US); Vitaliy Demin, Saco, ME (US); Bill Nelson, Sun Prairie, WI (US); Dan Marston, Old Orchard Beach, ME (US)

(73) Assignee: FRANKLIN FUELING SYSTEMS, INC., Madison, WI (US)

(21) Appl. No.: 13/446,282

(22) Filed: Apr. 13, 2012

Related U.S. Application Data
(60) Provisional application No. 61/545,655, filed on Oct. 11, 2011.
(60) Provisional application No. 61/476,068, filed on Apr. 15, 2011.

(51) Int. Cl. B67D 7/32

(52) U.S. Cl. 222/1; 222/23

(57) ABSTRACT

The present disclosure relates to a fuel delivery system and method for preventing and detecting phase separation in fuel storage tanks. Before phase separation occurs, the fuel delivery system may automatically warn a gas station operator to take preventative action. After phase separation occurs, the fuel delivery system may automatically shut down and warn the gas station operator to take corrective action.

### CROSS REFERENCE TO RELATED APPLICATIONS

This application claims priority from U.S. Provisional Patent Application Ser. No. 61/545,655, filed Oct. 11, 2011, and from U.S. Provisional Patent Application Ser. No. 61/476,068, filed Apr. 15, 2011, the disclosures of which are hereby expressly incorporated by reference herein in their entirety.

### FIELD OF THE DISCLOSURE

The present disclosure relates to monitoring fuel storage tanks and, in particular, to a method and apparatus for preventing and detecting phase separation in fuel storage tanks.

### BACKGROUND OF THE DISCLOSURE

Liquid storage tanks are widely relied upon to preserve and protect their contents. In particular, fuel storage tanks are an important part of the wider energy distribution system, and are routinely called upon to preserve liquid fuels during periods of storage while maintaining the fitness of the stored fuel for dispensation and use on short notice. Fuel storage tanks are commonly used, for example, to store gasoline at a gasoline filling station for distribution to end users (e.g., vehicle operators). Gasoline storage tanks are exposed to a wide variety of environmental conditions, and are often stored underground. Unintentional ingress of environmental moisture is a condition that can be encountered by these tanks.

Gasoline storage tanks often contain a blend of gasoline and alcohol, with blends having about 2.5 vol. % ethanol (“E-2.5”), 5 vol. % ethanol (“E-5”), or 10 vol. % ethanol (“E-10”) now commonly available as fuel for cars and trucks in the United States and abroad. Ethanol is a hygroscopic material, in that it attracts water from the air or from the surrounding environment. An excess amount of water in the gasoline/ethanol fuel blend will result in a condition known as phase separation. When phase separation occurs, excess alcohol, water and some constituents of the gasoline separate from the gasoline/ethanol fuel blend and form a new mixture (“phase separated fluid”) that is more dense than the gasoline/ethanol fuel blend but less dense than water. This phase separated fluid may comprise approximately 70 vol. % alcohol, 20 vol. % water, and 10 vol. % gasoline. If water infiltrates the storage tank quickly, it may settle at the bottom of the tank, below any phase separated fluid, without combining with the ethanol in the phase separated fluid or in the gasoline/ethanol fuel blend.

Dispenser pumps in fuel storage tanks are typically located near the bottom of the tank. If the phase separated fluid forms a thick enough layer at the bottom of the fuel storage tank, the phase separated fluid may be pumped into the tank of an end user, such as into an automobile gas tank. As a result, the automobile's engine may fail to start or may run poorly, and the phase separated fluid may have to be removed from the automobile's fuel system at substantial expense. If the water level becomes high enough to flow through the pump and into an automobile gas tank, significant damage to the automobile engine may result.

It would be desirable for a gasoline station operator to know whether phase separation and/or water ingress is occurring in the station's fuel storage tank. More particularly, it would be desirable for the gasoline station operator to know whether an alcohol/water/gasoline mixture resulting from the phase separation is at risk of forming or being pumped to a customer.

### SUMMARY

The present disclosure relates to a fuel delivery system and method for preventing and detecting phase separation in fuel storage tanks. Before phase separation occurs, the fuel delivery system may automatically warn a gas station operator to take preventative action. After phase separation occurs, the fuel delivery system may automatically shut down and warn the gas station operator to take corrective action.

According to an embodiment of the present disclosure, a fuel delivery system is provided including a storage tank containing a fuel product, the fuel product having a water content and a temperature, a fuel line in communication with the storage tank, a fuel dispenser in communication with the fuel line, the fuel dispenser being configured to dispense the fuel product to a customer, at least one monitor operatively positioned along the fuel line between the storage tank and the fuel dispenser, the at least one monitor collecting data indicative of the water content of the fuel product in the fuel line, and a controller in communication with the at least one monitor to receive collected data from the at least one monitor, the controller being programmed to automatically issue a warning based on the water content of the fuel product in the fuel line.

According to another embodiment of the present disclosure, a fuel delivery system is provided including a storage tank containing a fuel product, the fuel product having a water content, a fuel line having an inlet in communication with the storage tank, the fuel line being capable of receiving a first portion of the fuel product from the storage tank that is located at or above the inlet of the fuel line without receiving a second portion of the fuel product from the storage tank that is located beneath the inlet of the fuel line, at least one monitor operatively positioned along the fuel line, the at least one monitor collecting data indicative of the water content of the fuel product in the fuel line, and a controller in communication with the at least one monitor to receive collected data from the at least one monitor, the controller being programmed to automatically issue a warning based on the water content of the fuel product in the fuel line.

According to yet another embodiment of the present disclosure, a method is provided for monitoring a fuel delivery system including the steps of: directing a fuel product from a storage tank to a fuel dispenser via a fuel line; collecting data indicative of a water content of the fuel product in the fuel line; and automatically issuing a warning based on the collected data.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 is a schematic view of an exemplary fuel delivery system, the fuel delivery system including a fuel dispenser, a storage tank, and a controller;

FIG. 2 is a flowchart that represents a first software routine of the controller for preventing phase separation in the storage tank;

FIG. 3A is a graphical representation of the maximum acceptable water content in E-10 fuel for use by the controller;

FIG. 3B is a graphical representation of the maximum acceptable water content in E-5 fuel for use by the controller;

FIG. 3C is a graphical representation of the maximum acceptable water content in E-2.5 fuel for use by the controller;

FIG. 4 is a flowchart that represents a second software routine of the controller for preventing phase separation in the storage tank;

FIG. 5A is a flowchart that represents a third software routine of the controller for preventing phase separation in the storage tank;

FIG. 5B is a flowchart similar to FIG. 5A that represents a modified third software routine;

FIG. 6 is a flowchart that represents a fourth software routine of the controller for detecting phase separation in the storage tank;

FIG. 7 is a flowchart that represents a fifth software routine of the controller for detecting phase separation in the storage tank;

FIG. 8 is a flowchart that represents a sixth software routine of the controller for detecting phase separation in the storage tank; and

FIGS. 9A-9C are graphical representations of experimental turbidity data.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

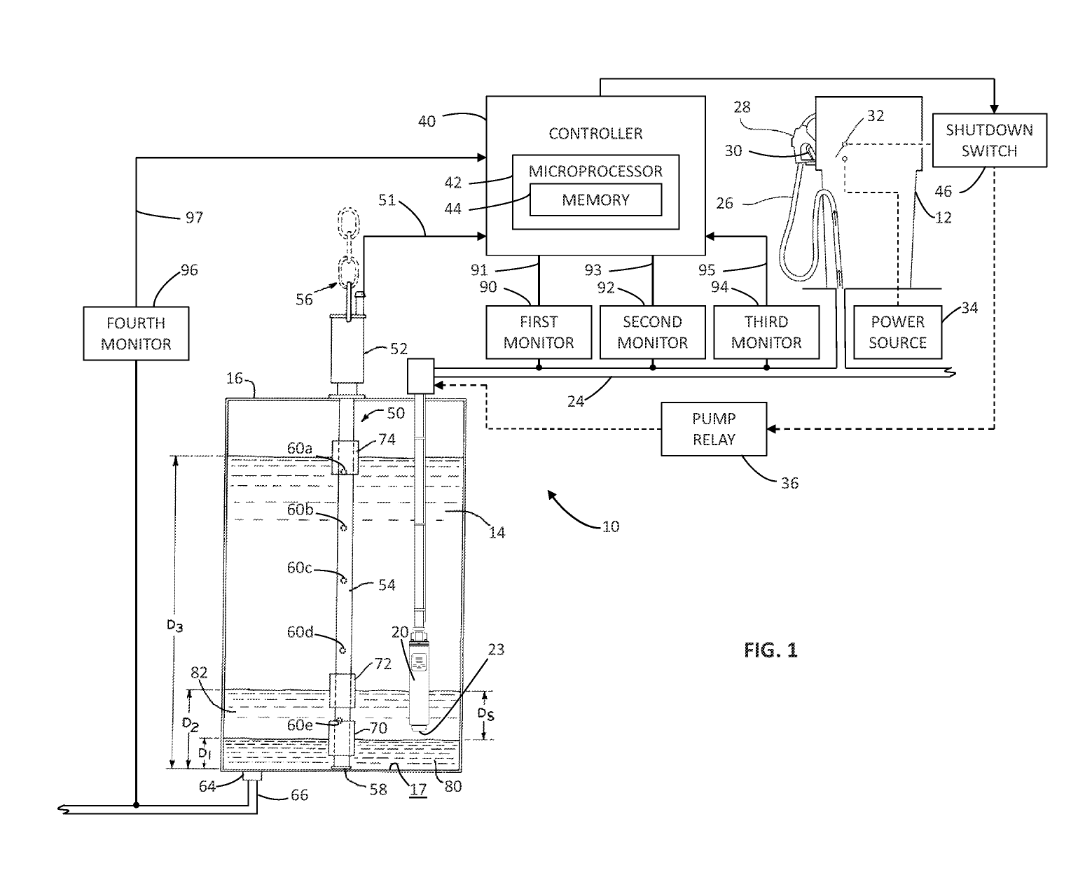

Referring initially to FIG. 1, an exemplary fuel delivery system 10 is shown that includes a fuel dispenser 12 for dispensing a liquid product, illustratively fuel 14, from a liquid storage tank 16. Storage tank 16 is illustratively positioned underground, but it is also within the scope of the present disclosure that storage tank 16 may be positioned above ground.

According to an exemplary embodiment of the present disclosure, fuel 14 is a gasoline/ethanol blend. The concentration of ethanol in the gasoline/ethanol blend may vary from 0 vol. % to 10 vol. % or more. As such, fuel 14 may contain about 2.5 vol. % ethanol (“E-2.5”), about 5 vol. % ethanol (“E-5”), about 7.5 vol. % ethanol (“E-7.5”), about 10 vol. % ethanol (“E-10”), about 15 vol. % ethanol (“E-15”), or more, for example.

Storage tank 16 includes an internal, submersible pump 20, as shown in FIG. 1. Upon request, pump 20 delivers fuel 14 from storage tank 16, through fuel line 24, through hose 26 of fuel dispenser 12, and out nozzle 28 of fuel dispenser 12 for use by an end user or customer. The customer may insert nozzle 28 into an automobile (not shown) such that fuel 14 is delivered into the automobile's gas tank, for example. Fuel line 24 is illustratively an underground pipeline, although other suitable fuel lines may be used.

As shown in FIG. 1, inlet 23 of pump 20 is located above the bottom surface 17 of storage tank 16. Pump 20 delivers fluid located at or above inlet 23 to fuel line 24. The elevated position of inlet 23 may ensure that, during normal operation, fuel line 24 receives and delivers fuel 14 to fuel dispenser 12, not water, contaminants, or other materials that may have settled beneath inlet 23 near the bottom surface 17 of storage tank 16. For a storage tank 16 that is 8 feet tall with an advertised capacity of 10,000 gallons (which may correlate to an actual capacity of about 9,750 gallons), for example, inlet 23 of pump 20 may be located about 3 inches, 5 inches, 7 inches, or more above the bottom surface 17 of storage tank 16. When storage tank 16 is substantially full with about 9,750 gallons of total fluid, the volume of fluid located beneath inlet 23 of pump 20 may equal about 150 gallons (1.5% of total fluid), 200 gallons (2.1% of total fluid), 250 gallons (2.6% of total fluid), or more, with the remaining fluid being located at or above inlet 23 of pump 20. As the size and shape of storage tank 16 changes, the location of pump 20 may also change.

Storage tank 16 further includes drain valve 64 located at the bottom surface 17 of storage tank 16, as shown in FIG. 1. Drain valve 64 may be opened and closed to selectively drain fluid from the bottom surface 17 of storage tank 16 via drain line 66. For example, drain valve 64 may be opened to drain water, contaminants, or other materials that may have settled beneath inlet 23 of pump 20 near the bottom surface 17 of storage tank 16.

To operate fuel dispenser 12, the customer removes nozzle 28 from its cradled position of FIG. 1 and presses trigger 30 on nozzle 28. One or both of these actions may close switch 32. Although nozzle 28 and/or trigger 30 are described herein as effecting movement of switch 32, it is also within the scope of the present disclosure that another user input (e.g., an on/off switch) may effect movement of switch 32. When switch 32 is closed, power source 34 supplies power to pump relay 36 and, as discussed above, pump 20 delivers fuel 14 from nozzle 28 of fuel dispenser 12 for use by the customer. When fueling is complete, the customer returns nozzle 28 to its cradled position of FIG. 1 and releases trigger 30 on nozzle 28. One or both of these actions may re-open switch 32. When switch 32 is re-opened, the electrical coupling between power source 34 and pump relay 36 is interrupted, which prevents pump relay 36 from being energized and terminates the operation of pump 20.

Referring still to FIG. 1, a controller 40 is provided to control and monitor the operation of fuel delivery system 10. In one embodiment, controller 40 is an electronic controller and includes a microprocessor 42 having an associated memory 44. Memory 44 is configured to store real-time and historical data and measurements from fuel delivery system 10, such as temperature data, volume data, and other data, as well as look-up tables and other reference data. Memory 44 is also configured to store software that contains instructions for operating microprocessor 42 to perform a variety of functions, including performing tests on fuel delivery system 10, collecting and analyzing data obtained from the tests, and determining a test conclusion based on the analyzed data. If controller 40 determines that fuel delivery system 10 fails a particular test, controller 40 may automatically shut down fuel delivery system 10. For example, controller 40 may automatically open shutdown switch 46 between power source 34 and pump relay 36, which prevents pump relay 36 from being energized and terminates the operation of pump 20.

An exemplary controller 40 is the TS-5 Fuel Management System available from Franklin Fueling Systems Inc. of Madison, Wis. However, it is within the scope of the present disclosure to use other controllers or microprocessors to perform the computing tasks described herein.

As shown in FIG. 1, a monitoring probe 50 is provided to collect data from storage tank 16 and to communicate the collected data to controller 40. The illustrative probe 50 sends an electric signal to controller 40 via wire 51, but it is also within the scope of the present disclosure that probe 50 may communicate wirelessly with controller 40.

An exemplary probe 50 is the TSP-LL2 Leak Detection and Inventory Control Probe available from Franklin Fueling Systems Inc. of Madison, Wis. However, it is within the scope of the present disclosure to use other probes to perform the monitoring tasks described herein.

The illustrative probe 50 of FIG. 1 includes head 52 and shaft 54 and is oriented generally vertically in storage tank 16. At the upper end of shaft 54, probe 50 includes an optional attachment mechanism 56 which may be selectively releasable and may provide for vertical adjustment of probe 50 in storage tank 16. At the lower end of shaft 54, probe 50 includes a base or stopper 58.

Probe 50 may be configured to measure the temperature of the fluid in storage tank 16. In the illustrated embodiment of FIG. 1, probe 50 includes a plurality of temperature sensors 60a, 60b, 60c, 60d, 60e, that are spaced substantially evenly across the length of shaft 54 to measure the temperature of the fluid at different heights in storage tank 16. Although probe 50 is shown and described herein as having five temperature sensors 60a, 60b, 60c, 60d, 60e, the number of temperature sensors and the spacing between adjacent temperature sensors may vary. An exemplary temperature sensor for use in probe 50 is a thermistor, for example. It is also within the scope of the present disclosure that the temperature of the fluid may be measured outside of storage tank 16, such as in fuel line 24.

Probe 50 may also be configured to measure the level of one or more fluids in storage tank 16. In the illustrated embodiment of FIG. 1, probe 50 includes a plurality of floats, including lower float 70, intermediate float 72, and upper float 74, which are slidably mounted on shaft 54. In operation, probe 50 may continuously determine the relative position of each float 70, 72, 74, along shaft 54 by creating an electromagnetic field in head 52 and measuring the time required for the electromagnetic field to interact with floats 70, 72, 74, and return to head 52. It is also within the scope of the present disclosure that probe 50 may operate using sonar-based measurements, a series of proximity switches, or laser-based measurements, for example. It is further within the scope of the present disclosure that floats 70, 72, 74, may be arranged side-by-side or separated, as opposed to being directly above or below one another (i.e., coaxially arranged on a common shaft 54).

In addition to fuel 14, which forms an upper layer of fluid in storage tank 16, other fluids may be present in storage tank 16, such as lower fluid 80 and intermediate fluid 82. Lower fluid 80 may include substantially pure water and have a specific gravity of approximately 1.0. Intermediate fluid 82 may include a mixture of alcohol, water, and a small amount of gasoline (e.g., a mixture of 70 vol. % alcohol, 20 vol. % water, and 10 vol. % gasoline) resulting from phase separation, also referred to as a phase separated fluid. The specific gravity of intermediate fluid 82 is less than the specific gravity of lower fluid 80. For example, intermediate fluid 82 may have a specific gravity of approximately 0.80 to 0.89, and more particularly above 0.81. The upper fluid or fuel 14 may be a gasoline/ethanol blend, as discussed above. The specific gravity of the upper fluid or fuel 14 is less than the specific gravity of intermediate fluid 82. For example, the upper fluid or fuel 14 may have a specific gravity of approximately 0.68 to 0.78, and more particularly 0.73 to 0.75.

Each float 70, 72, 74, is configured to settle atop a corresponding fluid in storage tank 16. Lower float 70 may have a relatively high density (e.g., a density corresponding to a specific gravity of approximately 0.95) to sink through the upper fluid or fuel 14 and intermediate fluid 82 and settle atop lower fluid 80. As shown in FIG. 1, lower float 70 has settled at a distance D₁ above the bottom surface 17 of storage tank 16. Upper float 74 may have a relatively low density (e.g., a density corresponding to a specific gravity of approximately 0.65) to settle atop upper fluid or fuel 14. As shown in FIG. 1, upper float 74 has settled at a distance D₃ above the bottom surface 17 of storage tank 16. Intermediate float 72 may have an intermediate density between that of lower float 70 and upper float 74 (e.g., a density corresponding to a specific gravity of approximately 0.80) to sink through the upper fluid or fuel 14 and settle atop intermediate fluid 82. As shown in FIG. 1, intermediate float 72 has settled at a distance D₂ above the bottom surface 17 of storage tank 16, which is greater than distance D₁ of lower float 70 and less than distance D₃ of upper float 74. The relationship between each float 70, 72, 74 and its corresponding fluid level may vary depending on the geometric shape of each float 70, 72, 74.

Additional information regarding the use of probe 50 to measure the level of one or more fluids in storage tank 16 is set forth in U.S. patent application Ser. No. 12/580,493, filed Oct. 16, 2009, entitled “Method and Apparatus for Detection of Phase Separation in Storage Tanks,” the entire disclosure of which is expressly incorporated herein by reference.

As shown in FIG. 1, various in-line monitors, including a first monitor 90, a second monitor 92, and a third monitor 94, are provided to collect data indicative of the water content of the fluid in fuel line 24 and to communicate the collected data to controller 40. In one embodiment, the data is collected and communicated to controller 40 in raw form, and then controller 40 calculates the water content of the fluid. In another embodiment, first monitor 90, second monitor 92, and/or third monitor 94 measures or calculates the water content of the fluid directly, and then outputs the water content to controller 40. Regardless of its form, the data that is communicated to controller 40 may be referred to herein as “water content data.”

In certain embodiments, the water content may be measured and communicated as a volume percentage of the total fluid flowing through fuel line 24 and/or in parts per million (ppm) on a volume (v/v) basis. For example, the first monitor 90 may measure and communicate a water content of 0.1 vol. % (where the remaining 99.9 vol. % constitutes fluid other than water) and/or a water content of 1000 ppm (v/v) (where the remaining 999,000 volume parts constitute fluid other than water). It is also within the scope of the present disclosure that the water content may be measured and communicated as a weight percentage of the total fluid flowing through fuel line 24 and/or in parts per million (ppm) on a weight (w/w) basis.

Monitors 90, 92, 94, may be positioned in any suitable location along fuel line 24 to analyze the fluid that is flowing from storage tank 16 via inlet 23 of pump 20 and to fuel dispenser 12. Although it is within the scope of the present disclosure that monitors 90, 92, 94, may be associated with fuel dispenser 12 (e.g., hose 26 of fuel dispenser 12), locating monitors 90, 92, 94, along a common fuel line 24 eliminates the need to provide monitors at each individual fuel dispenser 12. Also, although three in-line monitors 90, 92, 94, are illustrated and discussed herein, it is within the scope of the present disclosure that only one or two of these monitors may be provided. The illustrative monitors 90, 92, 94, send electric signals to controller 40 via corresponding wires 91, 93, 95, but it is also within the scope of the present disclosure that monitors 90, 92, 94, may communicate wirelessly with controller 40. In use, each monitor 90, 92, 94, may draw a sample from fuel line 24 and process that sample as necessary for testing.

The first monitor 90 of FIG. 1 may be a capacitance monitor that is configured to measure the capacitance of the fluid in fuel line 24. The first monitor 90 may also be capable of using the capacitance data to directly calculate and communicate the water content of the fluid in fuel line 24 to controller 40, as discussed above. An exemplary capacitance monitor, which may also be referred to as a water-in-fuel monitor, is the EASZ-1 system available from EESiFlo of Mechanicsburg, Pa. The EASZ-1 system operates by running an insulating fuel sample between opposing, charged metal plates and measuring capacitance. Knowing the size of the plates and the distance between the plates, the EASZ-1 system is able to calculate the dielectric constant of the intermediate fuel sample. Because the dielectric constant of gasoline is relatively low and the dielectric constant of water is relatively high, the lower the calculated value, the lower the water content of the intermediate fuel sample, and the higher the calculated value, the higher the water content of the intermediate fuel sample. The EASZ-1 system may operate continuously, measuring capacitance approximately once every second. It is also within the scope of the present disclosure to use other water-in-fuel monitors to measure the water content of the fluid in fuel line 24.

The second monitor 92 of FIG. 1 may be a turbidity monitor that is configured to measure the cloudiness or haziness of the fluid in fuel line 24 based on the quantity of suspended particles in the fluid. The second monitor 92 may also be capable of using the turbidity data to directly calculate and communicate the water content of the fluid in fuel line 24 to controller 40, as discussed above. Turbidity may be indicative of the fluid's water content because, as the water content increases toward phase separation, more and more particles may form in the fluid. When a source beam is directed through a fluid with a relatively low water content and a relatively small number of particles, the source beam may pass through the fluid relatively uninhibited. By contrast, when the source beam is directed through a fluid with a relatively high water content and a relatively large number of particles, the source beam may collide with and deflect off of the particles. For example, the turbidity monitor may include a light source and a detector that measures the light as it passes through the fluid in fuel line 24. It is also within the scope of the present disclosure that the turbidity monitor may include a sound source and a detector that measures the sound as it passes through the fluid in fuel line 24. The path of the source beam through the fluid may vary depending upon the properties of the particles themselves, such as the shape, color, and reflectivity of the particles. Thus, the path of the source beam may be calibrated for each location and/or situation.

In one embodiment, the turbidity monitor may measure attenuation (i.e., reduction in strength) of the source beam along its initial path as it passes through the fluid in fuel line 24. When the source beam is directed through a fluid with a relatively low water content and a relatively small number of particles, the beam will generally follow its initial path, so attenuation along the initial path will be relatively low. Stated differently, detection of the beam that remains along the initial path will be relatively high. By contrast, when the source beam is directed through a fluid with a relatively high water content and a relatively large number of particles, the beam will generally deviate from its initial path, so attenuation along the initial path will be relatively high. Stated differently, detection of the beam that remains along the initial path will be relatively low.

In another embodiment, the turbidity monitor may measure deflection of the source beam along a side path transverse to the initial path. When the source beam is directed through a fluid with a relatively low water content and a relatively small number of particles, the beam will generally follow its initial path, so detection of the beam along the side path will be relatively low. By contrast, when the source beam is directed through a fluid with a relatively high water content and a relatively large number of particles, the beam will generally deviate from its initial path, so detection of the beam along the side path will be relatively high.

Exemplary turbidity monitors are available from VWR International, LLC of Radnor, Pa., such as the Model 66120-200 Turbidity Meter. Such turbidity monitors may utilize a nephelometer having a light beam as the source beam and a light detector offset by about 90 degrees from the source beam. The nephelometer may output turbidity in units known as Nephelometric Turbidity Units (NTU).

To ensure that particles remain suspended in the fluid for detection by the turbidity monitor, the fluid should be in a dynamic and/or turbulent state during turbidity monitoring. If the fluid becomes too static before turbidity monitoring, the particles may settle in the fluid and avoid detection by the turbidity monitor. A turbidity monitor that operates continuously or substantially continuously may be capable of receiving and monitoring a dynamic fluid without allowing the fluid to become static between measurements.

The third monitor 94 of FIG. 1 may be a particle size monitor that is configured to measure the size of fluid particles flowing through fuel line 24. The third monitor 94 may also be capable of using the particle size data to directly calculate and communicate the water content of the fluid in fuel line 24 to controller 40, as discussed above. For example, the particle size monitor may take images of the fluid particles in fuel line 24 and use software to evaluate the size distribution of fluid particles in the images. As another example, the particle size monitor may include a light source, such as a laser light source, and a detector that detects the diffraction angle of the light as it passes through the fluid in fuel line 24. The particle size monitor may operate under a method known as Low Angle Laser Light Scattering (“LALLS”), which is based on the observation that particles passing through the laser source will scatter light at an angle that is inversely proportional to their size. As particle size decreases, the observed scattering angle increases logarithmically. Scattering intensity is also dependent on particle size, diminishing with particle volume. Therefore, larger fluid particles will scatter light at narrower diffraction angles with high intensity, and smaller fluid particles will scatter light at wider diffraction angles but with low intensity. Particle size may be indicative of the fluid's water content because, as the water content increases toward phase separation, larger and larger particles may form in the fluid.

In addition to monitors 90, 92, 94, a fourth monitor 96 may be provided to collect data from the fluid in drain line 66 and to communicate the collected data to controller 40. The illustrative fourth monitor 96 sends electric signals to controller 40 via a corresponding wire 97, but it is also within the scope of the present disclosure that the fourth monitor 96 may communicate wirelessly with controller 40. In use, the fourth monitor 96 may draw a sample from drain line 66 and process that sample as necessary for testing.

The fourth monitor 96 may be a capacitance monitor, like the first monitor 90, that is configured to measure the capacitance of the fluid in drain line 66. The fourth monitor 96 may also be capable of using the capacitance data to directly calculate and communicate the water content of the fluid in drain line 66 to controller 40, as discussed above. An exemplary capacitance monitor is the EASZ-1 system available from EESiFlo of Mechanicsburg, Pa. However, it is within the scope of the present disclosure to use other water-in-fuel monitors to measure the water content of the fluid in drain line 66.

In operation, controller 40 may receive continuous data feedback from probe 50 in storage tank 16, from one or more monitors 90, 92, 94, in fuel line 24, and/or from monitor 96 in drain line 66. Specifically, controller may receive continuous temperature data from temperature sensors 60a, 60b, 60c, 60d, 60e, in storage tank 16, continuous fluid height or volume data from floats 70, 72, 74, in storage tank 16, continuous water content data from monitors 90, 92, 94, 96 (e.g., continuous capacitance data from the first monitor 90 in fuel line 24, continuous turbidity data from the second monitor 92 in fuel line 24, continuous particle size data from the third monitor 94 in fuel line 24, and/or continuous capacitance data from the fourth monitor 96 in drain line 66). Microprocessor 42 of controller 40 runs the necessary software routines to collect, sort, and/or analyze this data.

According to an exemplary embodiment of the present disclosure, controller 40 signals an alarm or sends another suitable communication before phase separation occurs and before a phase separated fluid (e.g., intermediate fluid 82 of FIG. 1) forms in storage tank 16. In this embodiment, phase separation may be prevented.

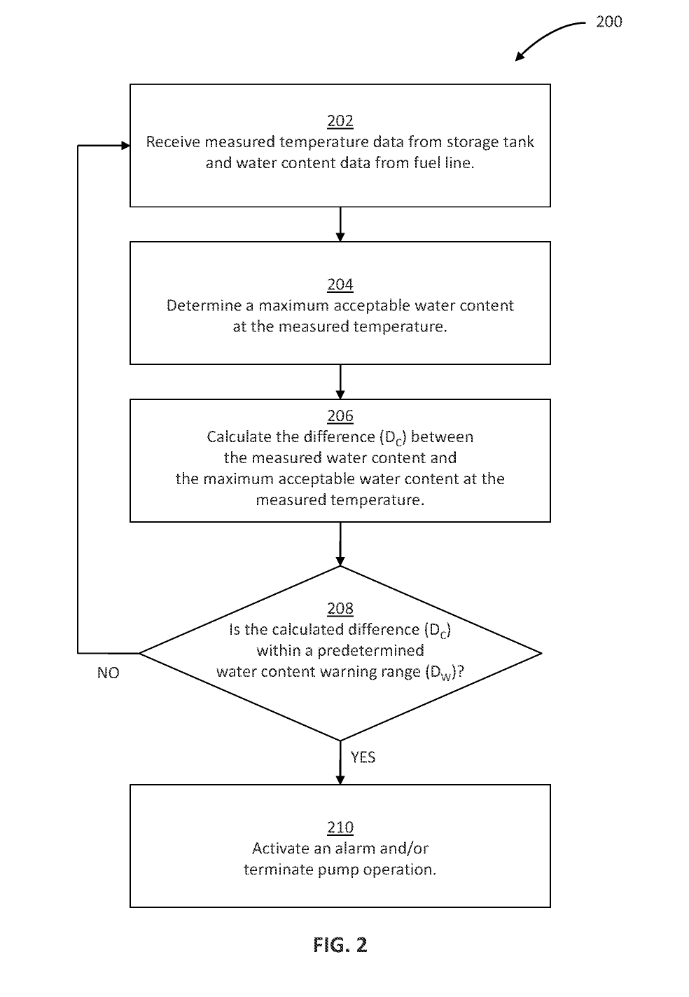

FIG. 2 provides a first software routine 200 for controller 40 that may prevent phase separation in storage tank 16 (FIG. 1). In step 202 of routine 200, controller 40 receives measured temperature data from temperature sensors 60a, 60b, 60c, 60d, 60e, and measured water content data (e.g., capacitance data) from the first monitor 90 (FIG. 1). Because different temperature readings may be received from each sensor 60a, 60b, 60c, 60d, 60e, controller 40 may use a minimum temperature measurement from sensors 60a, 60b, 60c, 60d, 60e, or an average temperature measurement from sensors 60a, 60b, 60c, 60d, 60e, for example.

Then, in step 204 of routine 200, controller 40 determines a maximum acceptable water content at the measured temperature. Above the maximum acceptable water content, the water content may be sufficient to cause phase separation. At or below the maximum acceptable water content, phase separation may be avoided. Because the solubility of water in a gasoline/ethanol blend varies based on the contents of the gasoline/ethanol blend (e.g., the concentration of ethanol in the blend, the presence of additives or blending agents in the blend, etc.) and temperature, the maximum acceptable water content may vary depending on the known or expected contents of storage tank 16 and the temperature in storage tank 16 (FIG. 1).

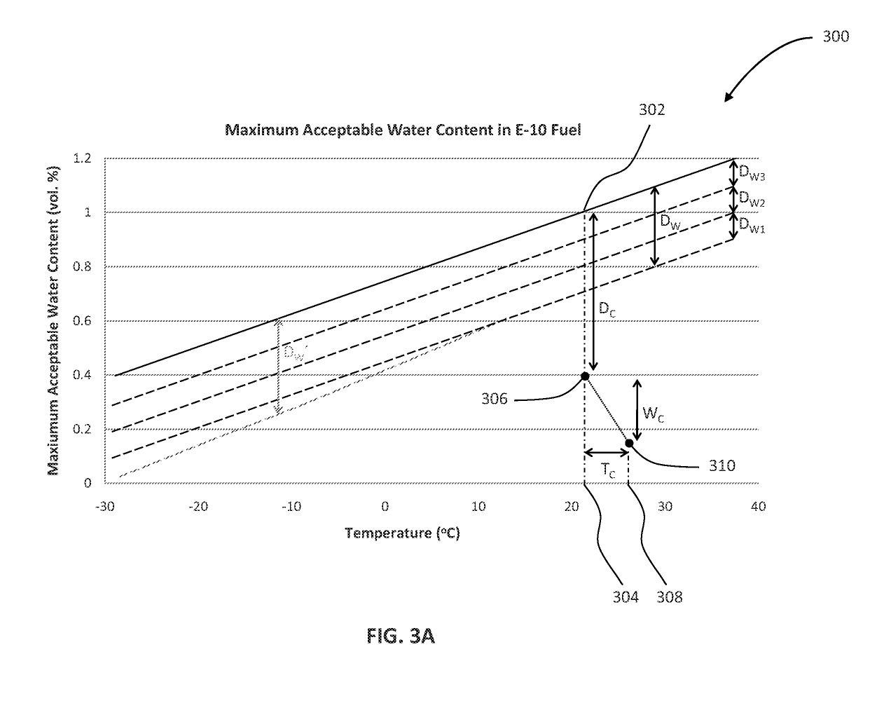

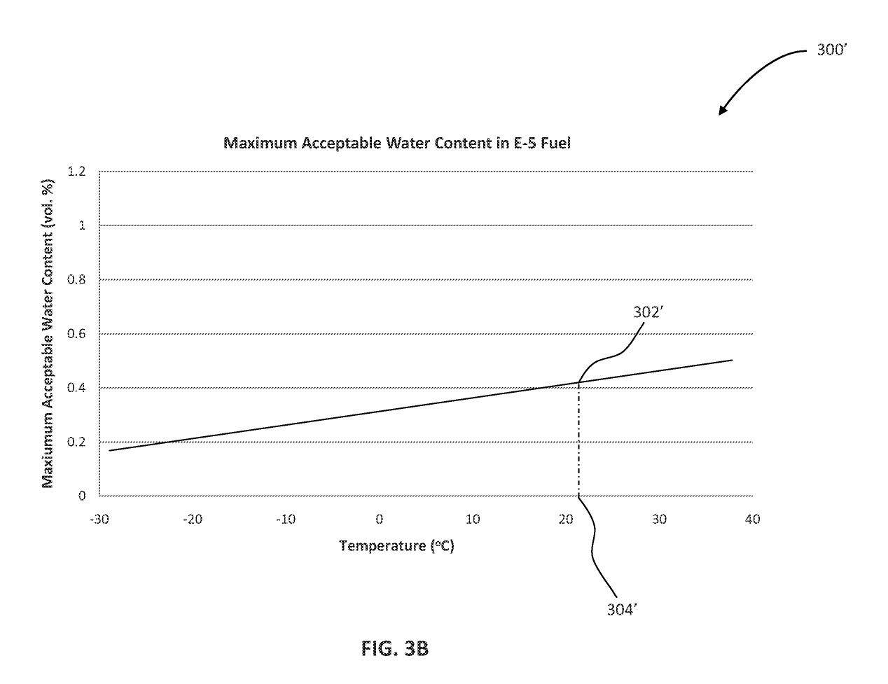

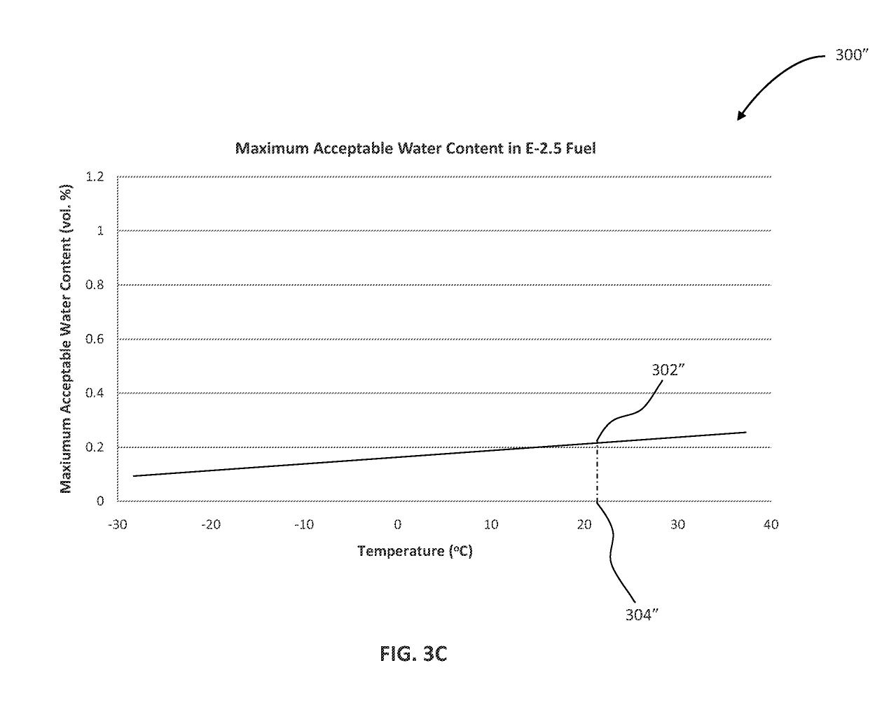

In one embodiment, controller 40 accesses a reference chart or table, such as charts 300, 300′, 300″, of FIGS. 3A-3C, to determine the maximum acceptable water content 302, 302′, 302″, at the measured temperature 304, 304′, 304″. Chart 300 of FIG. 3A may be used if storage tank 16 is known or expected to contain at least E-10 fuel, chart 300′ of FIG. 3B may be used if storage tank 16 is known or expected to contain at least E-5 fuel, and chart 300″ of FIG. 3C may be used if storage tank 16 is known or expected to contain less than 5 vol. % ethanol, such as E-2.5 fuel. At the same measured temperature 304, 304′, 304″, the maximum acceptable water content 302′ of FIG. 3B is less than the maximum acceptable water content 302 of FIG. 3A and is greater than the maximum acceptable water content 302″ of FIG. 3C. With its relatively low maximum acceptable water content 302″, chart 300″ of FIG. 3C or a similar chart may also be used if the contents of storage tank 16 are unknown or unpredictable, for example. Charts 300, 300′, 300″, may be stored in memory 44 of controller 40 (FIG. 1), and the appropriate chart 300, 300′, 300″, may be selected from memory 44 based on a user input to controller 40. For example, when re-filling storage tank 16, the fuel supplier or the gas station operator may input the ingredients of the new fuel blend into controller 40, and controller 40 may select the appropriate chart 300, 300′, 300″, from memory 44.

Next, in step 206 of routine 200, controller 40 calculates the difference between the measured water content of the fluid and the maximum acceptable water content at the measured temperature. For example, with reference to chart 300 of FIG. 3A, controller 40 calculates the difference D_{C} between the measured water content 306 and the maximum acceptable water content 302 at the measured temperature 304.

Then, in step 208 of routine 200, controller 40 evaluates the calculated difference D_{C} and responds accordingly. If the calculated difference D_{C} is relatively large, such that the measured water content 306 is safely beneath the maximum acceptable water content 302, as shown in FIG. 3A, controller 40 takes no responsive action and returns to step 202 to continue monitoring temperature data and water content data. On the other hand, if the calculated difference D_{C} is relatively small and is within a predetermined water content warning range D_{W}, controller 40 may activate an alarm or send another suitable warning communication in step 210. If calculated distance D_{C} is zero or less than zero, such that the measured water content 306 is at or above the maximum acceptable water content 302, controller 40 may also open shutdown switch 46 (FIG. 1) in step 210 to terminate the operation of pump 20 and to avoid dispensing any phase-separated fuel.

The size of the water content warning range D_{W} should be selected to provide an adequate, advanced warning to the gas station operator that phase separation is approaching. In the illustrated embodiment of FIG. 3A, for example, the water content warning range D_{W} is sized to activate the alarm of step 210 when calculated distance D_{C} is within about 0.3 vol. % of the maximum acceptable water content 302. It is also within the scope of the present disclosure that the size of the water content warning range D_{W} may vary. In the illustrated embodiment of FIG. 3A, for example, the size of the water content warning range D_{W}′ increases as the measured temperature 304 decreases and the maximum acceptable water content 302 decreases to provide more advanced warning to the gas station operator that phase separation is approaching.

In certain embodiments, controller 40 is programmed to progressively vary the alarm or warning communication across the water content warning range D_{W}. For example, in the illustrated embodiment of FIG. 3A, controller 40 is programmed to progressively vary the alarm or warning communication across warning ranges D_{W1}, D_{W2}, D_{W3}. If calculated distance D_{C} is within a first warning range D_{W1}, controller 40 may automatically trigger a minor alarm, such as a blinking light on fuel dispenser 12. If calculated distance D_{C} is within a second, intermediate warning range D_{W2}, controller 40 may automatically trigger a more severe alarm, such as an audible alarm on fuel dispenser 12. If calculated distance D_{C} is within a third warning range D_{W3}, controller 40 may automatically trigger an even more severe alarm, such as a telephone call or an e-mail to the gas station operator. If calculated distance D_{C} is zero or less than zero, such that the measured water content 306 is at or above the maximum acceptable water content 302, controller 40 may also open shutdown switch 46 (FIG. 1) in to terminate the operation of pump 20 and to avoid dispensing any phase-separated fuel.

The size of each warning range D_{W1}, D_{W2}, D_{W3}, should be selected to provide adequate, advanced warnings to the gas station operator that phase separation is approaching. In the illustrated embodiment of FIG. 3A, for example, warning range D_{W1} is sized to activate a minor alarm when calculated distance D_{C} is within about 0.2 vol. % to 0.3 vol. % of the maximum acceptable water content 302, warning range D_{W2} is sized to activate a more severe alarm when calculated distance D_{C} is within about 0.1 vol. % to 0.2 vol. % of the maximum acceptable water content 302, and warning range D_{W3} is sized to activate an even more severe alarm when calculated distance D_{C} is within about 0.1 vol. % of the maximum acceptable water content 302.

The alarm or warning communication from controller 40 in step 210 allows the gas station operator to take precautionary measures to avoid phase separation in storage tank 16 (FIG. 1). In certain embodiments, pump 20 may be shut down while the gas station operator takes these precautionary measures.

One precautionary measure involves increasing the ethanol content in storage tank 16 to increase the maximum acceptable water content of fuel 14, such as by adding an ethanol-rich fuel to storage tank 16. If storage tank 16 currently contains E-2.5 fuel, the gas station operator may add ethanol-rich, E-10 fuel to storage tank 16 to arrive at E-5 fuel, for example. Rather than having to operate under the low maximum acceptable water content 302″ of FIG. 3C that corresponds to E-2.5 fuel, the gas station operator may operate under the higher maximum acceptable water content 302′ of FIG. 3B that corresponds to E-5 fuel. Under the same logic, the alarm or warning communication from controller 40 may warn the gas station operator against decreasing the ethanol content in storage tank 16, such as by adding a low-ethanol fuel to storage tank 16.

Another precautionary measure involves decreasing the water content in storage tank 16, such as by draining some or all of the water-rich fuel 14 from drain line 66 of storage tank 16 and adding fresh, water-deficient fuel 14 to storage tank 16. Under the same logic, the alarm or warning communication from controller 40 may warn the gas station operator against increasing the water content in storage tank 16, such as by adding a water-rich fuel to storage tank 16.

Yet another precautionary measure could involve increasing the temperature of storage tank 16, such as by pumping a warm heat exchange fluid around storage tank 16. Under the same logic, the alarm or warning communication from controller 40 may warn the gas station operator against decreasing the temperature of storage tank 16, such as by adding a new supply of low-temperature fuel to storage tank 16.

In addition to receiving water content data (e.g., capacitance data) from the first monitor 90 (FIG. 1) in routine 200, controller 40 may also receive water content data (e.g., turbidity data) from the second monitor 92 and water content data (e.g., particle size data) from the third monitor 94. Before phase separation occurs, the fluid in fuel line 24 may become visibly hazy, and particles may form in the fluid. Therefore, if the second monitor 92 detects a haze or cloudiness in the fluid based on increasing turbidity measurements or turbidity measurements that are approaching a maximum acceptable turbidity level, for example, controller 40 may automatically trigger a severe alarm to warn the gas station operator of impending phase separation. Controller 40 may also automatically trigger an alarm if the third monitor 94 detects increasing particle sizes in the fluid.

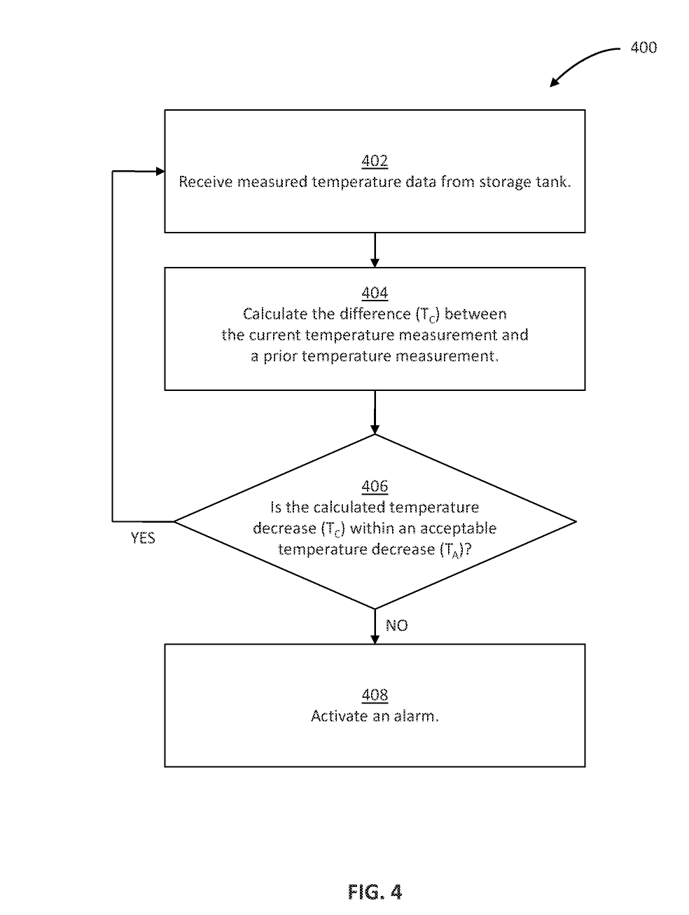

FIG. 4 provides a second software routine 400 for controller 40 that may prevent phase separation in storage tank 16 (FIG. 1). In step 402 of routine 400, controller 40 receives measured temperature data from temperature sensors 60a, 60b, 60c, 60d, 60e, in storage tank 16. Because different temperature readings may be received from each sensor 60a, 60b, 60c, 60d, 60e, controller 40 may use a minimum temperature measurement from sensors 60a, 60b, 60c, 60d, 60e, or an average temperature measurement from sensors 60a, 60b, 60c, 60d, 60e, for example.

Next, in step 404 of routine 400, controller 40 calculates the difference between the current temperature measurement and a prior temperature measurement, the prior temperature measurement being measured a predetermined time (e.g., 5, 10, or 15 seconds) before the current temperature measurement. With reference to chart 300 of FIG. 3A, for example, controller 40 calculates the difference T_{C} between the current temperature measurement 304 and the prior temperature measurement 308. Controller 40 may retrieve the prior temperature measurement 308 from memory 44 (FIG. 1).

Then, in step 406 of routine 400, controller 40 evaluates the calculated temperature change T_{C} and responds accordingly. If the calculated temperature change T_{C} over the predetermined time (i.e., the rate of temperature change) is relatively small, controller 40 takes no responsive action and returns to step 402 to continue monitoring temperature data. On the other hand, if the calculated temperature change T_{C} over the predetermined time (i.e., the rate of temperature change) is relatively large and exceeds an acceptable temperature change T_{A}, controller 40 may activate an alarm or send another suitable warning communication in step 408. The alarm of step 408 may be activated independently of the alarm of step 210 (FIG. 2). Therefore, even if the measured water content 306 is not within the water content warning range D_{W}, controller 40 may activate the alarm of step 408.

The size of the acceptable temperature change T_{A} should be selected to provide an adequate, advanced warning to the gas station operator that the temperature in storage tank 16 is dropping. It is also within the scope of the present disclosure that the size of the acceptable temperature change T_{A} may vary. For example, the size of the acceptable temperature change T_{A} may decrease (i.e., become more sensitive) as the measured temperature 304 decreases to provide more advanced warning to the gas station operator that the temperature in storage tank 16 is dropping.

The alarm or warning communication from controller 40 in step 408 allows the gas station operator to take precautionary measures to avoid phase separation in storage tank 16 (FIG. 1) or other storage tanks at the site. If controller 40 calculates an excessive temperature change T_{C} in storage tank 16 when re-filling storage tank 16 with a new fuel supply, for example, the gas station operator may recognize that the new fuel supply is too cold and could cause phase separation by lowering the temperature in storage tank 16. In response, the gas station operator may stop adding the cold fuel to storage tank 16 or other storage tanks at the site, especially storage tanks that are already operating within the water content warning range D_{W} (FIG. 3).

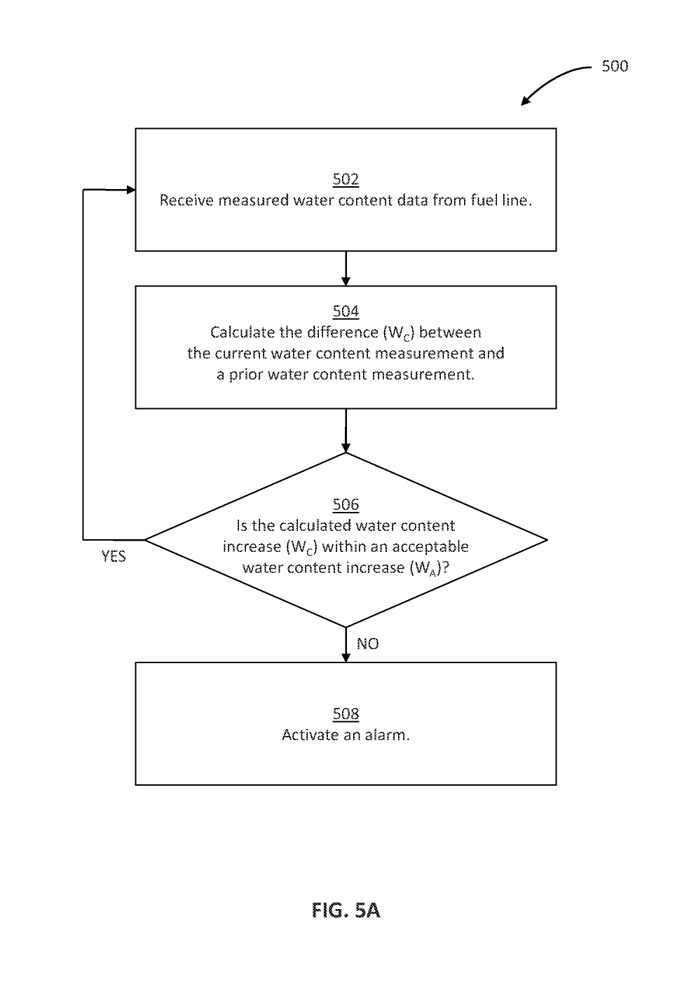

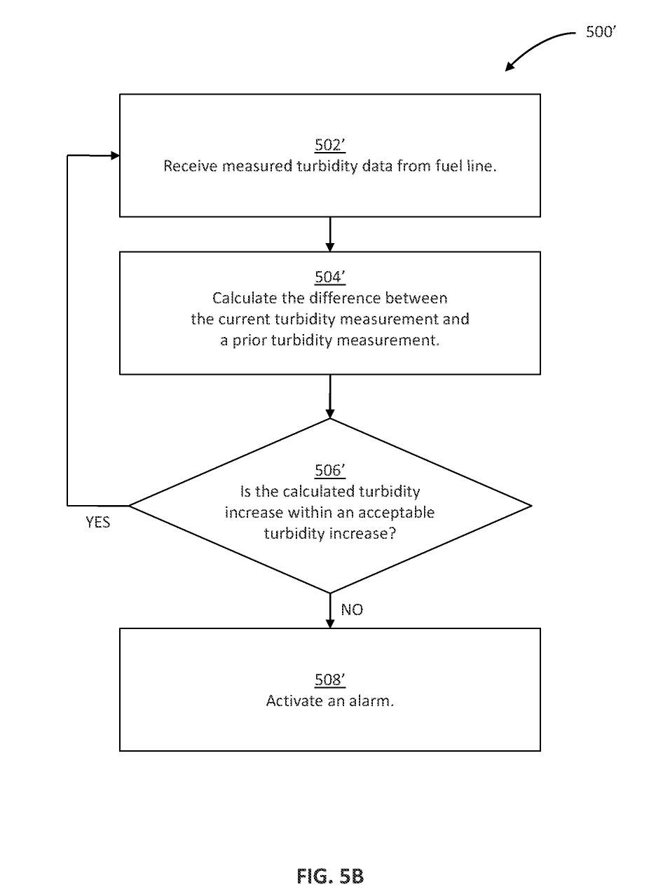

FIG. 5A provides a third software routine 500 for controller 40 that may prevent phase separation in storage tank 16 (FIG. 1). In step 502 of routine 500, controller 40 receives measured water content data (e.g., capacitance data) from the first monitor 90 in fuel line 24.

Next, in step 504 of routine 500, controller 40 calculates the difference between the current water content measurement and a prior water content measurement, the prior water content measurement being measured a predetermined time (e.g., 5, 10, or 15 seconds) before the current water content measurement. With reference to chart 300 of FIG. 3A, for example, controller 40 calculates the difference W_{C} between the current water content measurement 306 and the prior water content measurement 310. Controller 40 may retrieve the prior water content measurement 310 from memory 44 (FIG. 1).

Then, in step 506 of routine 500, controller 40 evaluates the calculated water content change W_{C} and responds accordingly. If the calculated water content change W_{C} over the predetermined time (i.e., the rate of water content change) is relatively small, controller 40 takes no responsive action and returns to step 502 to continue monitoring water content data. On the other hand, if the calculated water content change W_{C} over the predetermined time (i.e., the rate of water content change) is relatively large and exceeds an acceptable water content change W_{A}, controller 40 may activate an alarm or send another suitable warning communication in step 508. The alarm of step 508 may be activated independently of the alarm of step 210 (FIG. 2) and the alarm of step 408 (FIG. 4). Therefore, even if the measured water content 306 is not within the water content warning range D_{W}, controller 40 may activate the alarm of step 508.

The size of the acceptable water content change W_{A} should be selected to provide an adequate, advanced warning to the gas station operator that the water content in storage tank 16 is increasing. It is also within the scope of the present disclosure that the size of the acceptable water content change W_{A} may vary. For example, the size of the acceptable water content change W_{A} may decrease (i.e., become more sensitive) as the measured water content 306 increases to provide more advanced warning to the gas station operator that the water content in storage tank 16 is increasing.

The alarm or warning communication from controller 40 in step 508 allows the gas station operator to take precautionary measures to avoid phase separation in storage tank 16 (FIG. 1) or other storage tanks at the site. If controller 40 calculates an excessive water content change W_{C} in storage tank 16 when re-filling storage tank 16 with a new fuel supply, for example, the gas station operator may recognize that the new fuel supply contains too much water and could cause phase separation by increasing the water content in storage tank 16. In response, the gas station operator may stop adding the water-rich fuel to storage tank 16 or other storage tanks at the site, especially storage tanks that are already operating within the water content warning range D_{W} (FIG. 3). As another example, if controller 40 calculates an excessive water content change W_{C} in storage tank 16 outside of a re-filling operation, the gas station operator may recognize that water is leaking into storage tank 16 from the surrounding environment. In response, the gas station operator may inspect storage tank 16 for leaks or damage. Controller 40 may recognize that storage tank 16 is being re-filled by detecting a user input (e.g., an access code entry) from the fuel supplier or by sensing a higher fuel level in storage tank 16 (e.g., a rise of upper float 74) (FIG. 1).

The third software routine 500 may be adapted to receive measured water content data (e.g., turbidity data) from second monitor 92, as shown in the modified routine 500′ of FIG. 5B. Thus, in step 502′ of the modified routine 500′, controller 40 receives measured water content data (e.g., turbidity data) from the second monitor 92 in fuel line 24 (FIG. 1). Controller 40 may perform method 500′ of FIG. 5B instead of or in addition to routine 500 of FIG. 5A, so controller 40 may receive measured water content data (e.g., turbidity data) from the second monitor 92 instead of or in addition to measured water content data (e.g., capacitance data) from the first monitor 90.

Next, in step 504′ of routine 500′, controller 40 calculates the difference between the current turbidity measurement and a prior turbidity measurement, the prior turbidity measurement being measured a predetermined time (e.g., 5, 10, or 15 seconds) before the current turbidity measurement. Controller 40 may retrieve the prior turbidity measurement from memory 44 (FIG. 1).

Then, in step 506′ of routine 500′, controller 40 evaluates the calculated turbidity change and responds accordingly. In this manner, trends in the turbidity data may be evaluated without necessarily having to identify and reference a predetermined, maximum acceptable turbidity level. If the calculated turbidity change over the predetermined time (i.e., the rate of turbidity change) is relatively small, controller 40 takes no responsive action and returns to step 502′ to continue monitoring turbidity data. On the other hand, if the calculated turbidity change over the predetermined time (i.e., the rate of turbidity change) is relatively large and exceeds an acceptable turbidity change, controller 40 may activate an alarm or send another suitable warning communication in step 508′, as discussed further above.

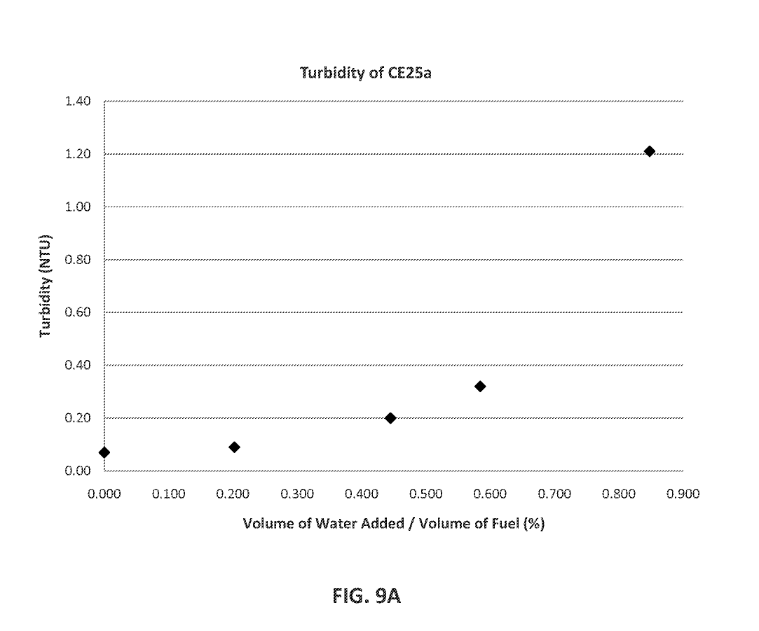

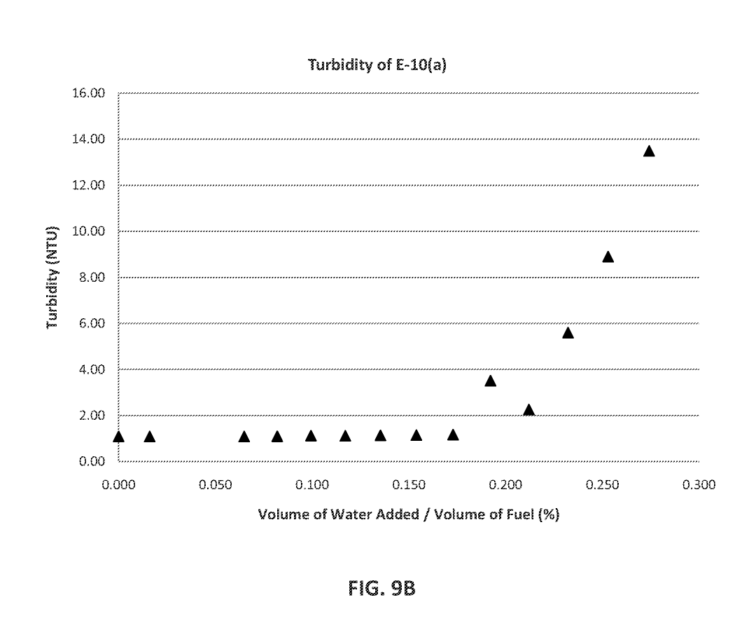

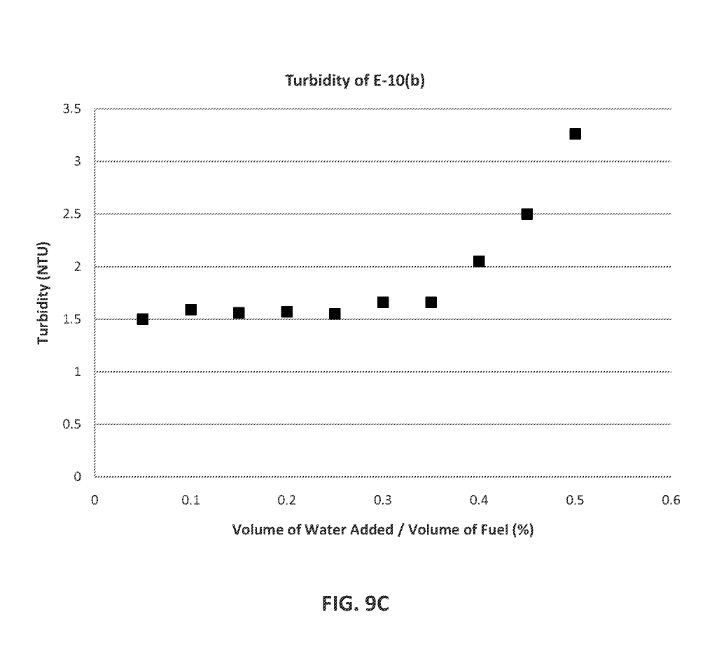

The size of the acceptable turbidity change should be selected to provide an adequate, advanced warning to the gas station operator that the water content in storage tank 16 is increasing. In the experimental example that follows (Table 1 and FIGS. 9A-9C), it is shown that turbidity remains generally constant as the water content initially increases, with measurements varying by about 0.00 NTU, 0.02 NTU, or 0.04 NTU, for example. But as the water content continues to increase toward phase separation, turbidity increases sharply, with measurements varying by about 0.10 NTU, 0.50 NTU, 1.00 NTU, or more. Based on this experimental data, the acceptable turbidity change over a predetermined time may be selected to be about 0.05 NTU, for example, with variances at or below 0.05 NTU being acceptable and variances above 0.05 NTU activating the alarm. The acceptable turbidity change may vary depending on the known or expected contents of storage tank 16 (FIG. 1).

An acceptable turbidity change may also be expressed as a percentage of a prior turbidity measurement (e.g., an initial turbidity measurement). According to an exemplary embodiment of the present disclosure, an acceptable turbidity change over a predetermined time may be about 15%, 20%, 25%, or 30% of the prior turbidity measurement if more sensitivity is desired, or about 35%, 40%, 45%, 50%, or more of the prior turbidity measurement if less sensitivity is desired. If a fuel product has an initial turbidity measurement of about 1.10 NTU, for example, a turbidity measurement that exceeds 1.27 NTU (which represents a 15% increase) or 1.65 NTU (which represents a 50% increase) may cause controller 40 to activate the alarm. It is also within the scope of the present disclosure to progressively vary the alarm as the turbidity measurements increase, as discussed above.

In another embodiment, step 506′ of routine 500′ involves evaluating a time-ordered series of turbidity measurements, such as the most recent 3, 5, 7, or more turbidity measurements. If each turbidity measurement in the series increases, controller 40 may activate the alarm. However, if one or more of the turbidity measurements in the series decreases, controller 40 may assume that turbidity is relatively constant and may return to step 502′ to continue monitoring water content data (e.g., turbidity data).

According to another exemplary embodiment of the present disclosure, controller 40 signals an alarm or sends another suitable communication after phase separation occurs. In the illustrated embodiment of FIG. 1, phase separation has already occurred, causing intermediate fluid 82 to separate from fuel 14. Although controller 40 may not prevent phase separation from occurring in this embodiment, controller 40 may detect phase separation and avoid delivering the phase separated, intermediate fluid 82 to the customer, such as by terminating the operation of pump 20.

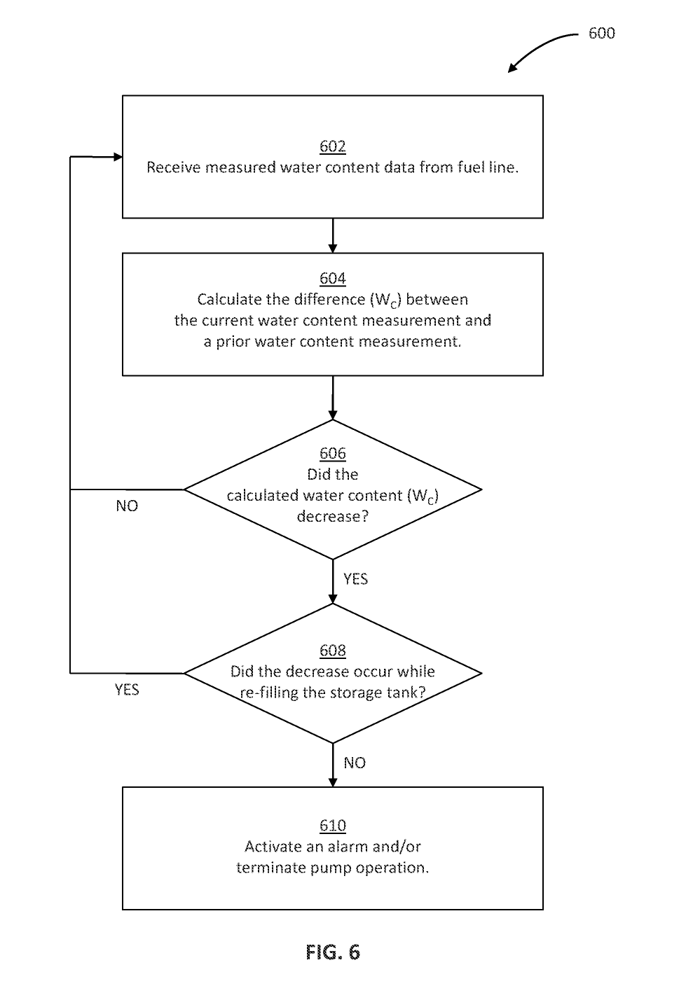

FIG. 6 provides a fourth software routine 600 for controller 40 that may detect phase separation in storage tank 16 (FIG. 1). Routine 600 is similar to routine 500 (FIG. 5A), in that controller 40 receives measured water content data (e.g., capacitance data) from the first monitor 90 (FIG. 1) in step 602 and calculates the water content change W_{C} between the current water content measurement and a prior water content measurement in step 604. However, unlike routine 500, which looks for the water content to increase, routine 600 looks for the water content to decrease in step 606, which may indicate that phase separation has occurred and that water has been extracted from fuel 14 and pulled into lower fluid 80 or intermediate fluid 82 (FIG. 1). In certain embodiments, the water content of the fluid in fuel line 24 may drop to about 0 vol. % after phase separation. If the calculated water content decrease W_{C} occurs while re-filling storage tank 16, controller 40 takes no responsive action and returns to step 602 to continue monitoring water content data (e.g., capacitance data). In this case, the water content decrease W_{C} would most likely be attributed to the delivery of fresh, water-deficient fuel to storage tank 16, not phase separation. On the other hand, if the calculated water content decrease W_{C} occurs outside of a re-filling operation, controller 40 may activate an alarm or send another suitable warning communication in step 610. Controller 40 may also open shutdown switch 46 (FIG. 1) in step 610 to terminate the operation of pump 20 and to avoid dispensing any phase-separated fuel.

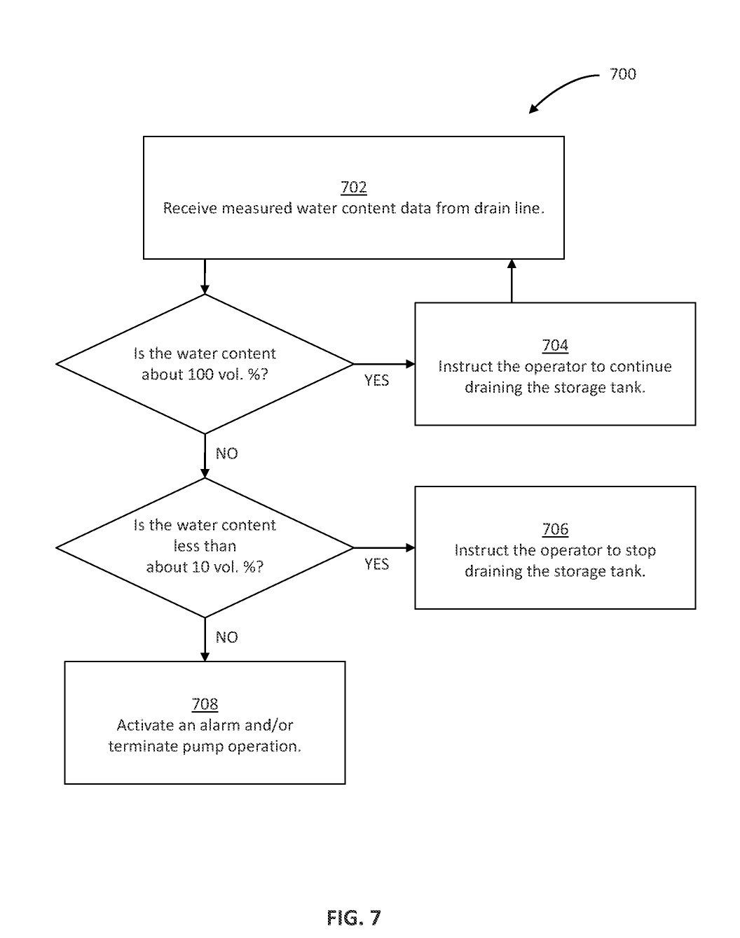

FIG. 7 provides a fifth software routine 700 for controller 40 that may detect phase separation in storage tank 16 (FIG. 1). In step 702 of routine 700, controller 40 receives measured water content data (e.g., capacitance data) from the fourth monitor 96 in drain line 66. A measured water content of approximately 100 vol. % would suggest that pure water (e.g., lower fluid 80 of FIG. 1) is being drained from drain line 66. In response, controller 40 instructs the gas station operator to continue draining storage tank 16 at step 704, and then controller 40 returns to step 702 to continue monitoring water content data (e.g., capacitance data). A measured water content less than about 5 vol. % or 10 vol. %, such as about 0.2 vol. %, 0.4 vol. %, 0.6 vol. %, 0.8 vol. %, or 1.0 vol. %, would suggest that a gasoline/ethanol fuel blend (e.g., fuel 14 of FIG. 1) is being drained from drain line 66. In response, controller 40 may instruct the gas station operator to stop draining storage tank 16 at step 706. A measured water content between about 10 vol. % and 100 vol. %, such as about 20 vol. %, would suggest that a phase separated fluid (e.g., intermediate fluid 82 of FIG. 1) is being drained from drain line 66. In response, controller 40 activates an alarm or sends another suitable warning communication in step 708. Controller 40 may also open shutdown switch 46 (FIG. 1) in step 708 to terminate the operation of pump 20 and to avoid dispensing any phase-separated fuel.

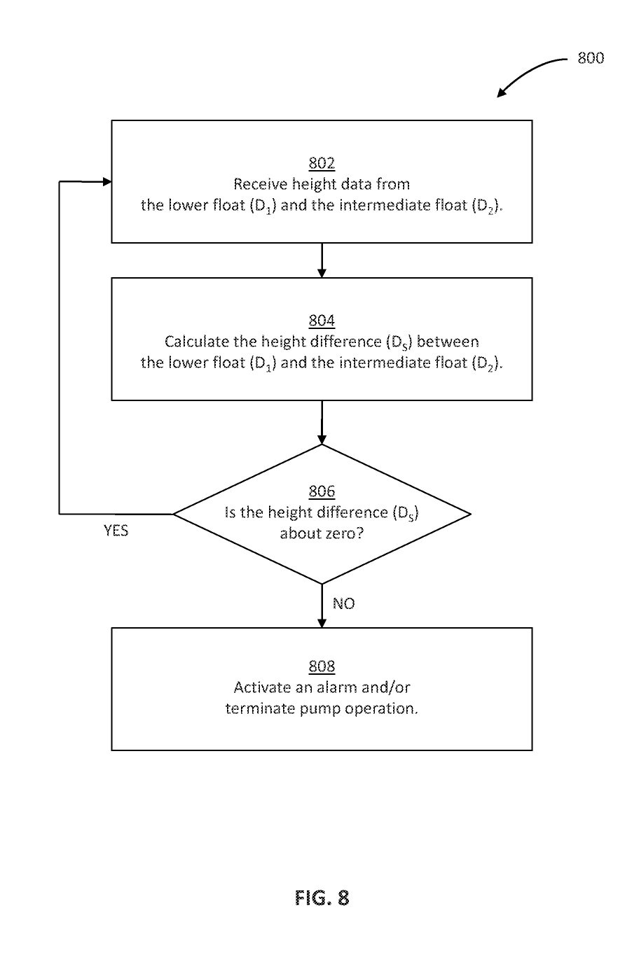

FIG. 8 provides a sixth software routine 800 for controller 40 that may detect phase separation in storage tank 16 (FIG. 1). In step 802 of routine 800, controller 40 receives height data corresponding to lower float 70 (e.g., D₁ of FIG. 1) and intermediate float 72 (e.g., D₂ of FIG. 1) of probe 50. In step 804 of routine 800, controller 40 calculates the height difference D_{S} between lower float 70 and intermediate float 72, which is generally representative of the height or thickness of the phase separated fluid (e.g., intermediate fluid 82 of FIG. 1). If the calculated height difference Ds is zero or is within a nominal value of zero, it may be inferred that intermediate fluid 82 is essentially nonexistent, so controller 40 takes no responsive action and returns to step 802 to continue monitoring height data. On the other hand, if the calculated height difference D_{S} is greater than zero by more than the nominal value, it may be inferred that intermediate fluid 82 exists, so controller 40 activates an alarm or sends another suitable warning communication in step 808. Controller 40 may also open shutdown switch 46 (FIG. 1) in step 808 to terminate the operation of pump 20 and to avoid dispensing any phase-separated fuel.

Additional information regarding the use of probe 50 to detect phase separation in storage tank 16 is set forth in the above-incorporated U.S. patent application Ser. No. 12/580,493, filed Oct. 16, 2009, entitled “Method and Apparatus for Detection of Phase Separation in Storage Tanks”

The alarms or warning communications from controller 40 in step 610 (FIG. 6), step 708 (FIG. 7), and step 808 (FIG. 8) allow the gas station operator to take corrective actions following phase separation in storage tank 16 (FIG. 1). One corrective action involves draining some or all of the fluid from storage tank 16. Because phase separation decreases the octane level of the separated fuel, another corrective action involves adding high-octane fuel to storage tank 16.

### Example

Turbidity testing was performed on three fuel products. The first fuel product was a CE25a reference blend, which includes 75 volume % ASTM Fuel C and 25 volume % ethanol, as set forth in SAE J1681. The second fuel product was an E-10 blend, referred to herein as E-10(a), sampled from a fueling station. The third fuel product was another E-10 blend, referred to herein as E-10(b), sampled from a different fueling station.

Samples were prepared by adding a desired amount of water to each fuel product, as set forth in Table 1 below. Each sample was disturbed by turning the sample tube back and forth to minimize static settling of any particles contained therein. Then, each disturbed sample was immediately evaluated using the above-described Model 66120-200 Turbidity Meter. Turbidity results are presented in Table 1 below and are also presented graphically in FIGS. 9A-9C.

TABLE 1

| | Volume of Water | | |
|---|---|---|---|
| | Added/Volume of | Turbidity | |
| Fuel Type | Fuel (%) | (NTU) | Notes |
| (1) CE25a | 0.000 | 0.07 | |
| | 0.202 | 0.09 | |
| | 0.445 | 0.20 | |
| | 0.584 | 0.32 | |
| | 0.848 | 1.21 | Visible phase separation |
| (2) E-10(a) | 0.000 | 1.09 | |
| | 0.016 | 1.09 | |
| | 0.065 | 1.09 | |
| | 0.082 | 1.10 | |
| | 0.099 | 1.13 | |
| | 0.117 | 1.12 | |
| | 0.135 | 1.14 | |
| | 0.154 | 1.15 | |
| | 0.173 | 1.17 | |
| | 0.192 | 3.51 | |
| | 0.212 | 2.26 | |
| | 0.232 | 5.60 | |
| | 0.253 | 8.90 | |
| | 0.274 | 13.49 | Visible phase separation |
| (3) E-10(b) | 0.000 | N/M | |
| | 0.051 | 1.50 | |
| | 0.102 | 1.59 | |
| | 0.155 | 1.56 | |
| | 0.208 | 1.57 | |
| | 0.263 | 1.55 | |
| | 0.319 | 1.66 | |
| | 0.376 | 1.66 | |
| | 0.435 | 2.05 | |
| | 0.495 | 2.50 | |
| | 0.556 | 3.26 | Visible phase separation |

The volume of water added to each fuel product was increased until visible phase separation occurred. With reference to Table 1 above, visible phase separation occurred in the first fuel product (CE25a) after 0.848 volume % of water had been added, in the second fuel product (E-10(a)) after 0.274 volume % of water had been added, and in the third fuel product (E-10(b)) after 0.556 volume % of water had been added. The initial water content, if any, of the second and third fuel products was unknown. The third fuel product may have contained less water than the second fuel product before testing, which would explain why the third fuel product was able to take on more water than the second fuel product during testing.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A fuel delivery system comprising:
a storage tank containing a fuel product, the fuel product having a water content and a temperature;
a fuel line in communication with the storage tank;
a fuel dispenser in communication with the fuel line, the fuel dispenser being configured to dispense the fuel product to a customer;
at least one monitor operatively positioned along the fuel line between the storage tank and the fuel dispenser, the at least one monitor collecting data indicative of the water content of the fuel product in the fuel line; and
a controller in communication with the at least one monitor to receive collected data from the at least one monitor, the controller being programmed to automatically issue a warning based on the water content of the fuel product in the fuel line.

2. The fuel delivery system of claim 1, wherein the controller is programmed to automatically issue the warning before the water content of the fuel product in the fuel line reaches a level that is sufficient to cause phase separation of the fuel product.

3. The fuel delivery system of claim 2, further comprising a temperature sensor that measures the temperature of the fuel product, wherein the controller is in communication with the temperature sensor to receive the measured temperature from the temperature sensor, and wherein the controller uses the measured temperature to determine the water content level that is sufficient to cause phase separation.

4. The fuel delivery system of claim 2, wherein the controller is programmed to automatically issue:
a first warning when the water content of the fuel product is relatively far apart from the water content level that is sufficient to cause phase separation; and
a second warning when the water content of the fuel product is relatively close to the water content level that is sufficient to cause phase separation.

5. The fuel delivery system of claim 4, wherein the second warning is more intense than the first warning.

6. The fuel delivery system of claim 1, wherein the at least one monitor directly calculates the water content of the fuel product.

7. The fuel delivery system of claim 1, wherein the at least one monitor is a capacitance monitor.

8. The fuel delivery system of claim 7, wherein the controller is programmed to automatically issue the warning when the capacitance monitor measures the water content of the fuel product to be within about 0.3 vol. % or less of a predetermined maximum acceptable water content.

9. The fuel delivery system of claim 8, wherein the predetermined maximum acceptable water content is stored in a memory of the controller.

10. The fuel delivery system of claim 1, wherein the at least one monitor is a turbidity monitor.

11. The fuel delivery system of claim 10, wherein the controller is programmed to automatically issue the warning when the turbidity monitor detects about a 15% increase or more in turbidity of the fuel product.

12. The fuel delivery system of claim 1, wherein the at least one monitor is a particle size monitor.

13. The fuel delivery system of claim 1, wherein the fuel product is a gasoline/ethanol blend.

14. The fuel delivery system of claim 1, further comprising a pump that delivers the fuel product from the storage tank to the fuel dispenser, the controller being programmed to automatically terminate operation of the pump when the water content of the fuel product reaches the level that is sufficient to cause phase separation.

15. A fuel delivery system comprising:
a storage tank containing a fuel product, the fuel product having a water content;
a fuel line having an inlet in communication with the storage tank, the fuel line being capable of receiving a first portion of the fuel product from the storage tank that is located at or above the inlet of the fuel line without receiving a second portion of the fuel product from the storage tank that is located beneath the inlet of the fuel line;
at least one monitor operatively positioned along the fuel line, the at least one monitor collecting data indicative of the water content of the fuel product in the fuel line; and
a controller in communication with the at least one monitor to receive collected data from the at least one monitor, the controller being programmed to automatically issue a warning based on the water content of the fuel product in the fuel line.

16. The fuel delivery system of claim 15, wherein the inlet of the fuel line is spaced above a bottom surface of the storage tank.

17. The fuel delivery system of claim 16, wherein the inlet of the fuel line is spaced above the bottom surface of the storage tank by about 3 inches or more.

18. The fuel delivery system of claim 15, wherein a submersible pump in the storage tank defines the inlet of the fuel line.

19. A method of monitoring a fuel delivery system comprising the steps of:
directing a fuel product from a storage tank to a fuel dispenser via a fuel line;
collecting data indicative of a water content of the fuel product in the fuel line; and
automatically issuing a warning based on the collected data.

20. The method of claim 19, wherein the issuing step is performed before the fuel product undergoes phase separation.

21. The method of claim 19, wherein the collecting step comprises measuring the capacitance of the fuel product using a capacitance monitor.

22. The method of claim 19, wherein the collecting step comprises measuring turbidity of the fuel product using a turbidity monitor.

23. The method of claim 19, further comprising the steps of:
detecting a temperature decrease of the fuel product; and
automatically issuing another warning based on the temperature decrease.

24. The method of claim 19, further comprising the step of automatically issuing another warning after the fuel product undergoes phase separation based on at least one of:
detecting a water content decrease in the fuel product outside of a filling operation using a monitor operatively positioned along the fuel line;
detecting the presence of a phase-separated fluid using a monitor operatively positioned along a drain line from the storage tank; and
detecting the presence of a phase-separated fluid using a float system operatively positioned in the storage tank.
